(19) United States
(12) Patent Application Publication
(10) Pub. No.: US 2010/0129013 A1
(43) Pub. Date: May 27, 2010

(54) Guide Rail Having Base Rail And Gear Rack, Method Of Making Same, Guide Assembly Including Same

(75) Inventors: Jonathan R. Schroeder, Machesney Park, IL (US); Timothy J. LeCrone, Rockford, IL (US); Joseph A. Binka, Belvidere, IL (US)

Correspondence Address: REINHART BOERNER VAN DEUREN P.C., 2215 PERRYGREEN WAY, ROCKFORD, IL, 61107, US

(73) Assignee: PACIFIC BEARING COMPANY, Rockford, IL (US)

(21) Appl. No.: 12/625,058

(22) Filed: Nov. 24, 2009

Related U.S. Application Data
(60) Provisional application No. 61/117,795, filed on Nov. 25, 2008.

(51) Int. Cl. F16C 29/06; B23P 11/00

(52) U.S. Cl. 384/45; 29/428

(57) ABSTRACT

A guide rail is provided. The guide rail includes a base rail and a gear rack mounted to the base rail. The guide rail also provides at least one race upon which a guide roller can ride. The guide rail defines a reference point related to the raceway that has a parallelism relative to the gear rack of less than or equal to 0.005 inches per foot along the length of the guide rail. Preferably, the reference point is defined directly by the raceway and the parallelism is less than or equal to 0.001 inches per foot. A method of forming the guide rail is also provided. The method includes machining the reference point into the guide rail and using the reference point to locate machining a seat for mounting the gear rack. A guide assembly including a guide rail and a carriage or frame structure is also provided.

### CROSS-REFERENCE TO RELATED PATENT APPLICATIONS

This patent application claims the benefit of U.S. Provisional Patent Application No. 61/117,795, filed Nov. 25, 2008, the disclosure and teachings of which are incorporated herein, in their entireties, by reference thereto.

### FIELD OF THE INVENTION

This invention generally relates to guide assemblies and more particularly to guide rails for linear motion.

### BACKGROUND OF THE INVENTION

Guide assemblies have been used for assisting in guided linear motion of many products including medical scanners, printer devices, machining devices and automatic door openers, such as for elevators.

Typically, a guide assembly will include a guide rail and a carriage or frame. The carriage or frame and the guide rail move relative to one another for coordinated linear motion. Typically, the carriage or frame will include at least one guide roller or similar rolling element that interacts with and rides on a raceway of the guide rail to provide smooth controlled linear relative motion between the guide rail and carriage or frame. In some instances, the carriage or frame may include a motor that operably engages the guide rail to drive the relative motion between the carriage or frame and the guide rail.

Unfortunately, due to standard methods of forming such guide rails, tolerances between the raceway and the portion of the guide rail operably engaged by the motor are insufficient and promote increased ware on the motor and structure that operably engages the guide rail.

The present invention relates to providing guide rails with increased precision to promote consistent and improved engagement between the guide rail and a cooperating motor over the current state of the art.

### BRIEF SUMMARY OF THE INVENTION

Embodiments of the present invention relate to guide rails having gear racks that are precision located relative to raceways of the guide rail along which motors that include gears that engage the gear racks move.

In one embodiment, a guide rail comprising at least one raceway, a gear rack and a base rail is provided. The at least one raceway interacts with a rolling member of a cooperating carriage or frame member. The raceway defines a reference point. The gear rack is mounted to the base rail and interacts with a pinion of a cooperating carriage or frame member. The gear rack and the reference point of the at least one raceway have a parallelism per linear foot of the guide rail of less than or equal to 0.005 inches.

In one embodiment, the parallelism is less than or equal to 0.001 inches per linear foot of the guide rail. Further, in some embodiments, the raceway may be provided by a hardened rail mounted to the base rail. In alternative embodiments, the raceway may be directly provided by the base rail.

Further yet, in an embodiment, the gear rack is mounted to the base rail free of any threaded connectors. In one implementation, the gear rack is mounted to the base rail by spring pins press fit through apertures formed through the base rail and the gear rack. This arrangement prevents the gear rack from loosening relative to the base rail due to vibrations within the structure. This arrangement also prevents additional areas for tolerance loss due to tightening of a threaded connector that can result in undesirable biasing of the gear rack relative to the base rail.

A method of forming a guide rail is also provided. The method includes forming a guide rail having at least one raceway and a gear rack mounted to a base rail. The method comprises the step of machining a first qualified reference point on the guide rail. The qualified reference point relating to the location of the raceway. The method also includes the step of machining a gear rack seat in the base rail. Further, the step of machining the gear rack seat in the base rail includes locating the gear rack seat off of the qualified reference point on the guide rail during the step of machining a gear rack seat.

In some methods, the first qualified reference point is directly provided by the raceway of the guide rail, thus machining of the reference point is provided by machining of the raceway.

In some methods, the guide rail includes a hardened rail, the hardened rail providing the raceway, the method further comprising the step of securing the hardened rail to the base rail. The step of securing the hardened rail to the base rail may occur prior to the step of machining the first qualified reference point and the step of machining a gear rack seat in the base rail. In this method, the step of machining a first qualified reference point may include machining a raceway onto the hardened rail, and the first qualified reference point is directly provided by the raceway.

The step of machining a first qualified reference point and the step of machining a gear rack seat in the base rail may be performed simultaneously on a continuous length of the guide rail. However, although they may be simultaneously performed, the step of machining a gear rack seat may be performed on a given axial location of the guide rail along its length after the step of machining a first qualified reference point at that same axial location. In other words, the machining devices need not be axially located at the same axial position along the guide rail during formation.

When no hardened rails are included, the step of machining the qualified reference point may include directly machining a raceway into the base rail.

Methods may also include the step of securing the gear rack to the base rail. This step may be performed free of threaded fasteners and may further comprise forming cooperating apertures through the base rail and gear rack and inserting a pin through the cooperating apertures. The step of forming cooperating apertures through the base rail and gear rack can occur in a single machining step.

Further, in those methods that require mounting a hardened rail, the step of securing the hardened rail to the base rail can occur after the step of machining the first qualified reference point. In this implementation, the base rail is most typically machined to provide the reference point and this machining of the base rail provides increased accuracy for locating the hardened rail. Further, the reference point is related to the raceway as the location of the raceway is related to the accuracy of the machining of the base rail prior to mounting the hardened rail onto the base rail.

Guide assemblies incorporating guide rails identified and manufactured by the methods identified are also provided. These guide assemblies include a pinion for engaging the gear rack and at least one guide roller or similar structure for interacting with the raceways of the guide rail. The parallelism between the gear rack and reference point relating to the raceway maintain a desired mesh between the pinion gear and the gear rack even if slight bows or variations for true straight occur in the guide rail.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an isometric illustration of a guide assembly according to an embodiment of the present invention.

FIG. 2 is an end profile illustration of the guide assembly of FIG. 1;

FIG. 3 is a bottom view illustration of the guide assembly of FIG. 1;

FIG. 4 is an isometric partial exploded illustration of the guide assembly of FIG. 1;

FIG. 5 is an end profile illustration of the guide rail of the guide assembly of FIG. 1;

FIG. 6 is an end profile illustration of an alternative embodiment of a guide rail according to the teachings of the present invention;

FIG. 7 is an end profile illustration of an alternative embodiment of a guide rail according to the teachings of the present invention; and

FIG. 8 is an end profile illustration of the guide rail of FIG. 5 with the hardened rails removed therefrom.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

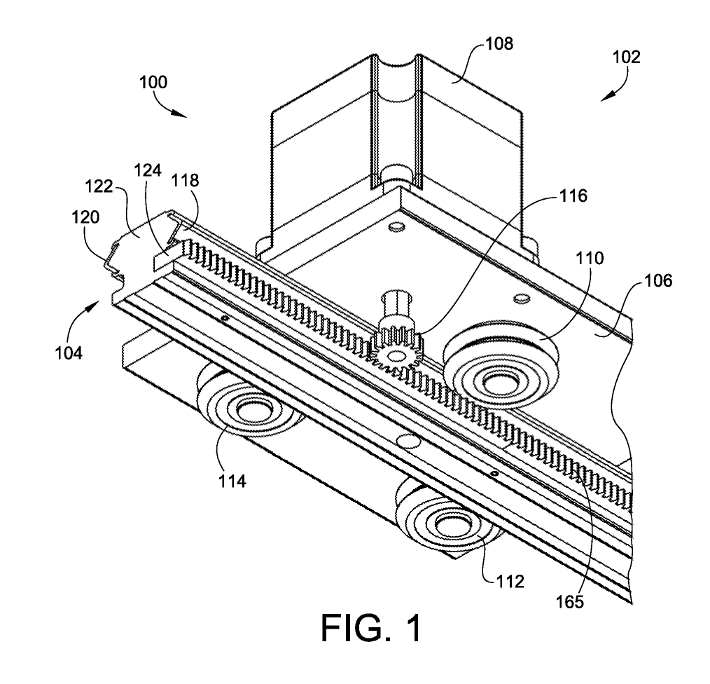

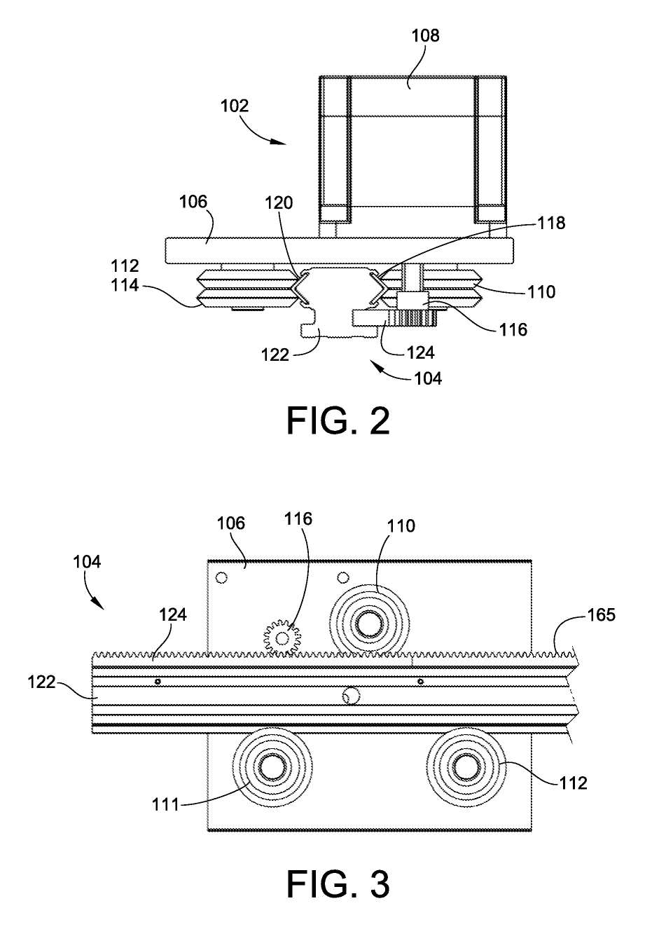

FIGS. 1-4 illustrate an embodiment of a guide assembly 100 that includes a carriage assembly 102 and a linear guide rail 104. The carriage assembly 102 and linear guide rail 104 are coupled for relative motion. Therefore, the carriage assembly 102 can be driven along the linear guide rail 104 to position devices attached to the carriage assembly 102 relative to the linear guide rail 104. Alternatively, the carriage assembly 102 could be in the form of a fixed position frame member that is in fact a stationary component relative to which the linear guide rail 104 moves. In this alternative arrangement, the linear guide rail 104 would be attached to a device to move the attached device relative to the carriage assembly 102.

The carriage assembly 102 generally includes a base member 106, a motor 108 and a plurality of guide rollers 110, 112, 114. The motor 108 and guide rollers 110, 112, 114 are operably mounted to the base member and are generally carried thereby. The motor 108 includes a pinion gear 116 that interacts with the linear guide rail 104 to drive the linear guide rail 104 and carriage assembly 102 relative to one another. The pinion gear 116 and guide rollers 110, 112, 114 have axes of rotation that are fixed relative to one another.

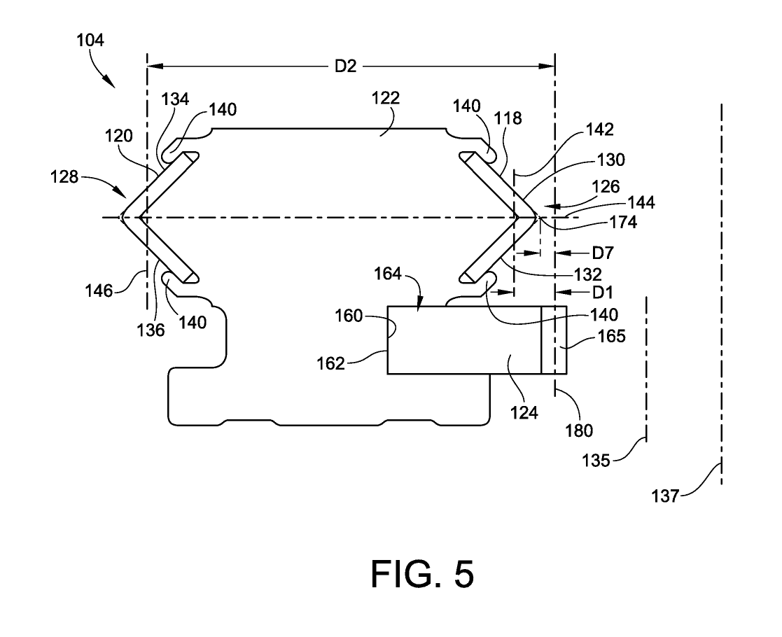

With further reference to FIG. 5, the linear guide rail 104 generally includes a pair of hardened rails 118, 120, a base rail 122 and gear rack 124. The hardened rails 118, 120 define raceways 126, 128 of the guide rail 104 upon which the guide rollers 110, 112, 114 ride and otherwise interact. In the illustrated embodiment, each of the hardened rails 118, 120 are V-shaped. Consequently, raceways 126, 128 defined by the hardened rails 118, 120 are similarly V-shaped and are defined by a pair of surfaces 130, 132 and 134, 136, respectively, upon which the guide rollers 110, 112, 114 directly ride. However, in other embodiments, the raceways 126, 128 could be provided by other profiles such as for example gothic arch profiles, a single groove, and the like for interacting with various guide rollers or alternatively directly with ball bearings. Thus, the raceways could be provided, for example, by convex and concave profiles depending on the cooperating structure of the carriage assembly 102.

By using V-shaped or similar raceways 126, 128, the raceways 126, 128 have lateral positioning structure that provides lateral stability in a direction parallel to the axis of rotation of a guide roller or other rolling member of a cooperating carriage assembly 102, as the carriage assembly 102 travels along the length of the linear guide rail 104. Other shapes of raceways can be used to provide for lateral stability.

Typically, base rail 122 is a light weight material such as aluminum while the hardened rails 118, 120 are formed from a harder material such as steel. However, other materials can be used.

The hardened rails 118, 120 are preferably swaged to the base rail 122. More particularly, fingers 140 are bent over (i.e. swaged) distal ends of the hardened rails 118, 120 to secure the hardened rails 118, 120 to the base rail 122. However, in alternative embodiments, the hardened rails 118, 120 could be secured to base rail 122 using other means such as mechanical fasteners.

The gear rack 124 is mechanically fastened to the base rail 122. More particularly, the base rail 122 includes a gear rack mounting channel 164 in which the gear rack is mounted. The gear rack channel 164 is laterally offset from the hardened rails 118, 120 and arranged such that the axis of rotation 135 of pinion 116 is parallel to the axes of rotation 137 of the guide rollers 110, 112, 114 (the axes illustrated schematically as dashed lines in FIG. 5). The gear rack mounting channel 164 includes a gear rack seat 160 upon which a bottom surface 162 of the gear rack 124 is mounted. The bottom surface 162 faces away from and is on the opposite side of teeth 165 of gear rack 164 As will be more fully described below, the gear rack seat 160 is a precision located and machined surface that has a high tolerance related to one or more of the raceways 126, 128 to provide precision interaction between the gear rack 124 and a cooperating pinion gear 116 of the carriage assembly 102.

In the illustrated embodiment, the gear rack 124 is mounted to the base rail 122 free of threaded fasteners. This eliminates a first location for tolerance to be lost. More particularly, the use of threaded fasteners can result in the fasteners jacking the gear rack 124 relative to the base rail 122 thereby changing the desired position of the gear rack relative to the raceways 126, 128. Further, the use of threaded fasteners is time consuming and costly during manufacture because this method of connection requires tapping and threading the base rail 122 for receipt of a cooperating screw or bolt. Additionally, the threaded fasteners are more expensive than other modes of connection, such as laid out below. Further, threaded fasteners are source of potential loosening between the gear rack 124 and base rail 122 due to vibrations.

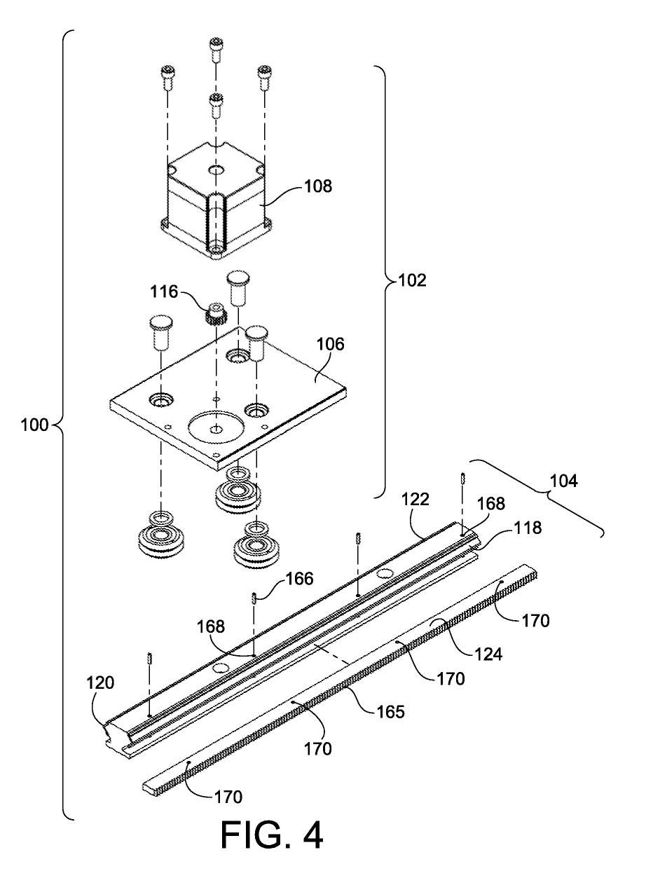

With primary reference to FIG. 4, in the illustrated embodiment, the gear rack 124 is mechanically fastened to the base rail 122 using pins 166 pressed through aligned holes 168, 170 of the base rail 122 and gear rack 124, respectively. In one embodiment, the holes 168, 170 are formed simultaneously with the gear rack 124 affixed or located within the gear rack mounting channel 164. Thus, when hole 168 is drilled through base rail 122 cooperating hole 170 of the gear rack 124 is also simultaneously formed. Pin 166 is then inserted through the pair of holes 168, 170 to prevent any shifting or misalignment of the gear rack 124 relative to the base rail 122.

In the illustrated embodiment, pins 166 are spring pins that are press fit into holes 168, 170 to prevent any clearance between the pins 166 and inner diameters of holes 168, 170.

Rack and pinion systems are only as accurate as the running relationship between the pinion and the gear rack. A predetermined gap setting is specified for optimal rack and pinion gear life and for minimal backlash, as well as reduced friction. Older methods of shimming or jacking the rack into a position to maintain the optimal gap settings are time consuming and often unattainable. Thus, a highly precise relationship between the raceways and the gear rack substantially improves performance of systems incorporating such guide rails that include gear racks.

With reference to FIG. 5, a linear guide rail 104, but not all linear guide rails, according to one embodiment will have a non-accumulative per foot parallelism between a plane defined by the pitch diameter of the gear rack 124 and a reference point defined by at least one of the raceways 126, 128 that is less than or equal to 0.005 inches, and more preferably less than or equal to 0.002 inches and most preferably less than or equal to 0.001 inches.

This parallelism maintains the desired gap spacing between a pinion gear 116 (illustrated by axis of rotation 137) mounted to a carriage assembly 102 and the gear rack 124. Variations in this gap will cause premature wear, excessive backlash, noise, and friction.

Because the pinion gear 116 is carried by the carriage assembly 102, its position relative to the gear rack 124 is directly influenced by raceways 126, 128. Thus, if the raceways 126, 128 remain parallel to the pitch diameter 140 of the gear rack 124, the pinion gear 116-to-gear rack 124 spacing will remain constant and the desired mesh between the two components will be maintained to prevent unnecessary wear or friction between the two components or alternatively inadequate mesh that can create damage to the teeth of either gear component.

The non-accumulative per foot parallelism can be measured as any one of the per foot variation in distances D1, D2 or D7 illustrated in FIG. 5. Distance D7 is a distance between a theoretical point 174 defined by a theoretical intersection of surfaces 130, 132 of raceway 126.

However, because the desired precision relates to a variation (i.e. delta) in distances D1, D2, D7 between a reference point defined by the raceways 126, 128 and the plane defined by the pitch diameter 180 of the gear rack, any point that a guide roller or cooperating portion of the carriage assembly 102 would ride on raceways 126, 128 can be used to measure the parallelism. For example reference points 142, 146 are theoretical locations where a guide roller may ride on raceways 126, 128. For the illustrated embodiment, reference points 142, 146 are planes or lines that extend perpendicular relative to a central dividing line/plane 144 that passes through the theoretical intersections of the surfaces of raceways 126, 128. Thus, a tool that includes a cooperating profile of the raceways 126, 128 could be mounted to the raceways 126, 128 and used as a constant reference point relative to the gear rack 124 during determining the variation in parallelism. Most preferably, the parallelism determined from the desired location on the raceways where the cooperating guide rollers or similar structure will ride on the raceways.

By maintaining the desired parallelism, if a slight variation from true straight occurs in the raceways 126, 128, the variation should also be found in the gear rack 124, within the desired tolerance. The variation maintains the proper spacing between the pinion gear 116, whose position is ultimately determined by raceways 126, 128, and the gear rack 124.

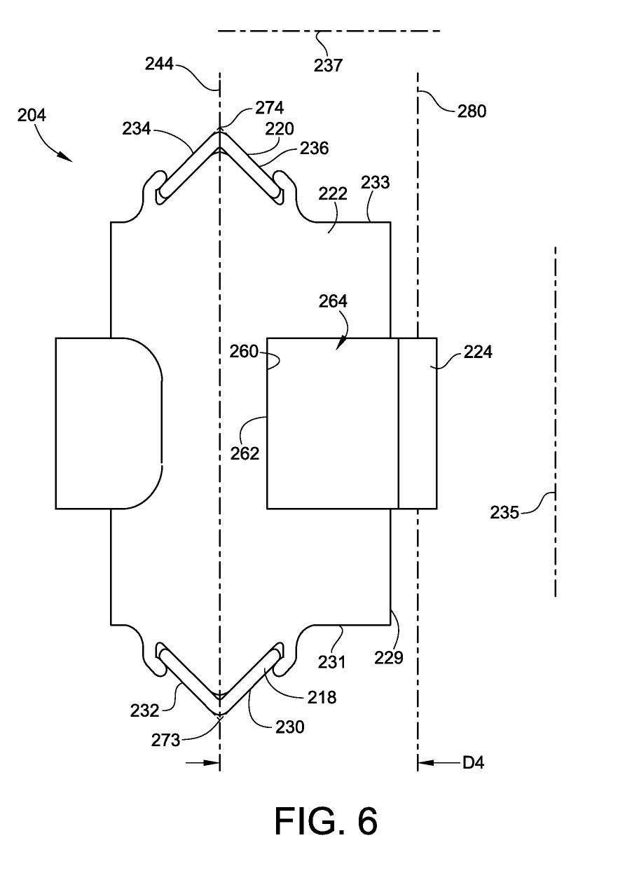

FIG. 6 illustrates another embodiment of a linear guide rail 204 having a different configuration than that of FIG. 1. In this arrangement, the linear guide rail 204 includes a pair of hardened rails 218, 220 mounted to a base rail 222. The linear guide rail 204 also includes a gear rack 224 mounted within a gear rack channel 264 of the base rail 222. Again, the gear rack channel 264 defines a gear rack seat 260 upon which a bottom surface 262 of the gear rack 224 abuts when the gear rack 224 is mounted to base rail 222.

However, in this embodiment, the gear rack 224 is mounted in a side 229 of the base rail 222 that is angularly oblique to the sides 231, 233 (perpendicular in the illustrated embodiment) that includes hardened rails 218, 220, respectively. This arrangement is used when a pinion gear that engages gear rack 224 is driven about an axis 235 that is perpendicular to axis 237 about which a guide roller that rides on hardened rails 218, 220 rotates. However, as the position (i.e. mesh) of the pinion relative to the gear rack 224 is determined by the relative position of raceways defined by hardened rails 218, 220, parallelism between the raceways and the gear rack 224 is important to maintain the desired gear mesh between the gear rack 224 and a cooperating pinion.

In this arrangement, parallelism can be measured as the variation (also referred to as a delta) in lateral distance D4 along the length of the linear guide rail 204. Distance D4 is defined between the pitch diameter 280 of gear rack 224 and a hypothetical axis 244 defined by reference points 273, 274 defined by hardened rails 218, 220, respectively. Reference points 273, 274 are defined by the intersection of surfaces 232, 230 and 234, 236, respectively. Again, further locating can be used to measure the parallelism.

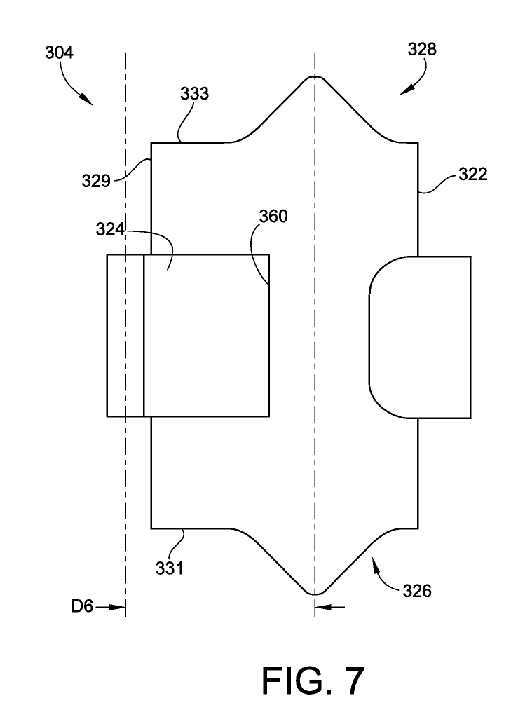

A further embodiment of a guide rail 304 is illustrated in FIG. 7. This embodiment is similar to the embodiment of FIG. 6 in that gear rack 324 is formed in side 329 of base rail 322. Side 329 extend obliquely to sides 331, 333 of base rail 322. However, this embodiment is free of hardened rails to define the raceways.

In this embodiment, raceways 326, 328 are formed directly in to the base rail 322. More particularly, raceway 326 is formed by side 331 and raceway 328 is formed by side 333.

In this embodiment, parallelism is the variation in distance D6 and is substantially similar to distance D4 for the previous embodiment.

Returning to the embodiment of FIGS. 1-5, methods of forming the linear guide rails 104 to establish this high-precision parallel relationship between the pitch diameter 180 of the gear rack 124 and the raceways 126, 128 will now be described.

To provide the high tolerance desired by the linear guide rail 104 of the instant invention, the relative location of the gear rack 124 relative to the raceways 126, 128 is the desired parameter to control.

One method of forming the linear guide rail 104 includes machining a qualified reference point defined by the linear guide rail 104 as well as machining a gear rack seat 160 in a base rail 122 of the linear guide rail 104. The step of machining the gear rack seat 160 in the base rail 122 includes locating the machining processes of the gear rack seat 160 off of the first qualified reference point. In a preferred embodiment, the qualified reference point is defined by at least one of the raceways 126, 128 of the linear guide rail 104. To locate off of the first qualified reference point, the reference point may ride on a predefined structure of the machining apparatus, such as a guide roller having a known position.

In one implementation of a method of forming the linear guide rail 104, the raceways 126, 128 of the linear guide rail 104 and the gear rack seat 160 are machined simultaneously and at a same axial position. This arrangement prevents multiple positioning steps of the base rail 122 during machining

Further yet, in another implementation, the method includes first securing hardened rails 118, 120 to the base rail 122 and then simultaneously machining the raceways 126, 128 onto hardened rails 118, 120, respectively, along with machining the gear rack seat 160.

While the steps of machining raceways 126, 128 and gear rack seat 160 may be performed simultaneously, the simultaneous machining may be performed at different axial locations along the linear guide rail 104. For instance, the step of machining the raceways 126, 128 may be performed axially upstream on a length of the linear guide rail 104 relative the step of machining the gear rack seat 160. Alternatively, this may be reversed.

In other words, a given axial location of the raceways 126, 128 of a linear guide rail 104 may be machined prior to the machining of the gear rack seat 160 for that same axial position along the length of the linear guide rail 104.

Alternatively, when no hardened rails are used, such as in the embodiment of FIG. 7, the raceways 326, 328 may be machined directly into base rail 322 as gear rack seat 360 is machined into base rail 322. Thus, in this embodiment, the raceways 326, 328 and gear rack seat 360 are formed in and provided by a single piece of material. Again, the machining of the raceways 326, 328 and gear rack seat 32 may be performed simultaneously or subsequently, but are preferably performed simultaneously.

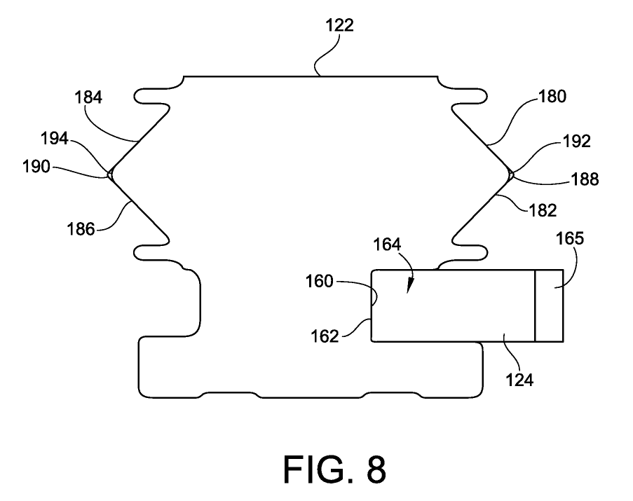

Further implementations of methods of forming the linear guide rail 104 may not require having the raceways 126, 128 define reference point for locating the gear rack seat 160. With reference to FIG. 8, the method may use support surfaces 180, 182, 184, 186 that support hardened rails 118, 120 to define the reference point for locating machining of gear rack seat 160. Again, the reference point may be the hypothetical intersections 188, 190 of support surfaces 180, 182 and 184, 186. Alternatively, the reference point could be the tips 192, 194 of the support profiles of the base rail 122 merging surfaces 180, 182 and 184, 186 into one another. Thus, in some embodiments, the reference point may not be directly established by the raceways of the linear guide rail.

In FIG. 8, support surfaces 180, 182, 184, 186 are precision machined prior to addition of hardened rails 118, 120. By precision machining support surfaces 180, 182, 184, 186 prior to mounting hardened rails 118, 120 to base rail 122, the hardened rails 118, 120 are more precisely located relative to base rail 122. In some embodiments, the location is sufficient that hardened rails 118, 120 need not be subsequently machined after being mounted to base rail 122.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of forming a guide rail having at least one raceway and a gear rack mounted to a base rail, the method comprising the steps of:
machining a first qualified reference point relating to the raceway on the guide rail;
machining a gear rack seat in the base rail; and
wherein the step of machining the gear rack seat in the base rail includes locating the gear rack seat off of the qualified reference point on the guide rail during the step of machining a gear rack seat.

2. The method of claim 1, wherein the first qualified reference point is directly provided by the raceway of the guide rail.

3. The method of claim 1, wherein the guide rail includes a hardened rail, the hardened rail providing the raceway, the method further comprising the step of securing the hardened rail to the base rail.

4. The method of claim 3, wherein the step of securing the hardened rail to the base rail occurs prior to the step of machining the first qualified reference point and the step of machining a gear rack seat in the base rail.

5. The method of claim 4, wherein the step of machining a first qualified reference point includes machining a raceway onto the hardened rail, and the first qualified reference point is directly provided by the raceway.

6. The method of claim 5, wherein the step of machining a first qualified reference point and the step of machining a gear rack seat in the base rail are performed simultaneously on a continuous length of the guide rail.

7. The method of claim 6, wherein the step of machining a gear rack seat is performed on a given axial location of the guide rail along its length after the step of machining a first qualified reference point at that same axial location.

8. The method of claim 2, wherein the qualified reference point and gear rack seat are formed on the base rail such that the qualified reference point and gear rack seat are both provided by a single piece of material.

9. The method of claim 8, wherein the step of machining a first qualified reference point and the step of machining a gear rack seat in the base rail are performed simultaneously on a continuous length of the guide rail.

10. The method of claim 1, further comprising the step of securing the gear rack to the base rail;
wherein the step of securing the gear rack to the base rail is free of threaded fasteners and further comprises forming cooperating apertures through the base rail and gear rack and inserting a pin through the cooperating apertures; and
wherein the step of forming cooperating apertures through the base rail and gear rack occur in a single machining step.

11. The method of claim 1, wherein the gear rack seat and the first qualified reference point have a per foot parallelism variation that is less than or equal to 0.005 inches.

12. The method of claim 11, wherein the gear rack seat and the first qualified reference point have a per foot parallelism variation less than or equal to 0.001 inches.

13. The method of claim 5, wherein the gear rack seat and the first qualified reference point provided by the raceway have a per foot parallelism variation of less than or equal to 0.002 inches.

14. The method of claim 10, wherein the gear rack has a pitch diameter and the first qualified reference point and the pitch diameter of the gear rack have a per foot parallelism variation less than or equal to 0.001 inches.

15. The method of claim 3, wherein the step of securing the hardened rail to the base rail occurs after the step of machining the first qualified reference point; and
wherein the steps of machining a first qualified reference point on the guide rail and machining a gear rack seat in the base rail occur simultaneously.

16. A guide rail comprising:
at least one raceway for interacting with a rolling member, the raceway defining a reference point;
a gear rack;
a base rail to which the gear rack is mounted; and
wherein the gear rack and the reference point of the at least one raceway having a parallelism per linear foot of the guide rail of less than or equal to 0.005 inches.

17. The guide rail of claim 16, wherein the parallelism per linear foot is less than or equal to 0.001 inches.

18. The guide rail of claim 17, further comprising at least one hardened rail mounted to the base rail, the at least one hardened rail providing the at least one raceway and defining the reference point.

19. A guide assembly comprising:
a guide rail including a base rail and a gear rack running along the length of the base rail, the guide rail defining a raceway along its length, the raceway defining a reference point along its length, the gear rack and reference point having a parallelism per linear foot of less than or equal to 0.005 inches; and
a drive arrangement including at least one guide roller riding on the raceway in parallel motion with the reference point; and
wherein the pinion gear moves relative to the gear track in a direction perpendicular to an axis of rotation of the pinion gear no more than the parallelism per linear foot as the drive arrangement moves relative to the guide rail along its length.

20. The guide rail of claim 19, wherein the parallelism per linear foot between the reference point and the gear rack is less than or equal to 0.001 inches.

21. The guide rail of claim 19, wherein the drive arrangement includes a base member and a motor, the pinion coupled to the motor, the motor and at least one guide roller mounted to the base member in such a manner that the rotational axes of the pinion and the guide roller are fixed relative to one another.
